(19) United States
(12) Patent Application Publication
(10) Pub. No.: US 2024/0029691 A1
(43) Pub. Date: Jan. 25, 2024

(54) INTERFACE CUSTOMIZED GENERATION OF GAMING MUSIC

(71) Applicant: Sony Interactive Entertainment LLC, San Mateo, CA (US)

(72) Inventors: Charles MCCOY, San Diego, CA (US); True XIONG, San Diego, CA (US)

(73) Assignee: Sony Interactive Entertainment LLC, San Mateo, CA (US)

(21) Appl. No.: 17/871,307

(22) Filed: Jul. 22, 2022

(51) Int. Cl. G10H 1/00; A63F 13/54

(52) U.S. Cl. CPC G10H 1/0008; A63F 13/54

(57) ABSTRACT

System, process and device configurations are provided for interface customized generation of gaming music. A method can include generating a musical accompaniment for electronic gaming by way of an interface. An interface is provided for a gaming system to provide at least one parameter for dynamic music generation. A game system may provide an application programming interface (API) for use with an electronic game to generate music. Generation of music by way of an interface may allow for exchange of one or more of user preferences, identification of a musical motif, and a musical style influence. The interface may allow for transfer of metadata for use in creating dynamic music. The interface may allow for operations of rendering dynamic music on a first device to be supplied to a second device.

### CROSS-REFERENCE TO RELATED APPLICATION

This application is concurrently filed with U.S. patent application Ser. No. ______ titled USER PREFERENCE CUSTOMIZED GENERATION OF GAMING MUSIC, U.S. patent application Ser. No. ______ titled USER INTERACTION CUSTOMIZED GENERATION OF GAMING MUSIC, U.S. patent application Ser. No. ______ titled CUSTOMIZED AUDIO SPECTRUM GENERATION OF GAMING MUSIC, and U.S. patent application Ser. No. ______ titled GAME ENVIRONMENT CUSTOMIZED GENERATION OF GAMING MUSIC, the specifications of which are hereby expressly incorporated by reference in their entirety.

### FIELD

The present disclosure is directed to generating audio for electronic games and customizing game audio and gaming music, including music orchestration, music learning, game design and game generation.

### BACKGROUND

Music in electronic games (e.g., video games, computer games, gaming platforms, application-based games, etc.) is generally pre-recorded and played as a loop to accompany video components of the game. Games can often include multiple music recordings for output, the recordings generated during development of a game. There is a desire to increase personalization of music and audio for games and gaming content beyond prerecorded loops. For many electronic games, there is no option or ability of a user to modify music or audio accompaniment beyond controlling volume. Muting game volume may also mute sound effects and other audio output of the game. There exists a desire for personalization of gaming content.

Another issue with game systems is the need to format game elements for different gaming markets. Gaming has a worldwide fan base serving many game titles and different regions. Certain features of a game, such as a musical style, may not be well received by game players. Development for additional markets and regions may be costly and impose additional data requirements for storage. Another difficulty of personalizing games and gaming content is identifying features that will enhance the experience of a user. There exists a need and desire for customized gaming music to compliment user experience.

### BRIEF SUMMARY OF THE EMBODIMENTS

Disclosed and described herein are systems, methods and configurations for interface customized generation of gaming music. In one embodiment, a method is provided for detecting, by a device, a request for gaming music by way of a software interface service, the request including at least one parameter for a game state, and generating, by the device, gaming music in response to the request, wherein the gaming music is generated dynamically to include at least one musical motif, the at least one motif selected based on the at least one parameter for the game state. The method also includes outputting, by the device, the gaming music.

In one embodiment, the request is formatted according to the software interface service to include the at least one parameter for the game state and music type.

In one embodiment, the request is received by the device by network communication and an application programming interface (API).

In one embodiment, the game state is a current gaming situation within an electronic game, and wherein the at least one parameter includes a type of music.

In one embodiment, the at least one user parameter for gaming music includes at least one of a music genre, music style, song title, identification of a musical artist, composer, user feedback, and musical preference.

In one embodiment, generating gaming music includes selection of a musical motif for game elements of the game state, wherein the selection of the motif is directed by the at least one user preference.

In one embodiment, generating gaming music includes selection of a music library based on the user preference and generating the gaming music from one or more motifs of the music library.

In one embodiment, outputting the gaming music includes output of dynamic music in coordination with output of gaming content.

In one embodiment, outputting the gaming music includes output of dynamic music by way of the software interface service.

In one embodiment, outputting the gaming music includes transfer of metadata for creation of dynamic music by way of the software interface service.

Another embodiment is directed to directed to a device configured for interface customized generation of gaming music. The device includes a memory storing executable instructions and a controller, coupled to the memory. The controller is configured to detect a request for gaming music by way of a software interface service, the request including at least one parameter for a game state, and generate gaming music in response to the request, wherein the gaming music is generated dynamically to include at least one musical motif, the at least one motif selected based on the at least one parameter for the game state. The controller is also configured to output the gaming music.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of customized music generation according to one or more embodiments;

FIG. 2 illustrates a process for interface customized music generation according to one or more embodiments;

FIG. 3 illustrates a graphical representation of user preference customization according to one or more embodiments;

FIG. 4 illustrates a graphical representation of dynamic music generation according to one or more embodiments;

FIG. 5 illustrates a graphical representation of user interface according to one or more embodiments; and

FIG. 6 illustrates a graphical representation of devices for interface customized music generation according to one or more embodiments.

### DETAILED DESCRIPTION OF THE EXEMPLARY EMBODIMENTS

### Overview and Terminology

One aspect of the disclosure is directed to generating customized game audio, such as gaming music and gaming sound effects. By customizing operations and audio generation, gaming audio may be more personalized and output may be tailored to a user, user environment and user condition. Processes and frameworks are provided for enabling devices, such as gaming consoles, and systems to generate game audio. Features discussed herein referring to gaming music may be applied to other types of audio, including but not limited to sound effects. In addition, generating gaming music as discussed herein may include generating musical and/or non-musical audio accompaniment for an electronic game. It should be appreciated that gaming music may include one or more sound voicings, such as vocal and/or instrumental sounds in such a way as to produce a sounds which can include an arrangement of sound having melody, rhythm and in some cases harmony. Gaming music may be generated as one or more tracks for output. According to embodiments, gaming music is generated and output dynamically, such that the audio output is determined and output by a device during game play.

Embodiments are directed to interface customized generation of gaming music. Systems and methods can include generating a music accompaniment for electronic games by way of an interface, such as a software interface service or application program interface (API), to provide at least one parameter for music generation. According to embodiments, a game system may provide an interface for games and game media in order to generate music. The interface may allow for parameters to be exchanged, including one or more music generation preferences, identifications of type of music (e.g., genre, style, etc.) and motifs. According to embodiments, the interface may allow for information related to a game to be communicated with the game system and/or another device in order to generate music. Parameters communicated with the interface can include one or more of genres to be generated, musical motifs to be specified for game elements and music clips to seed music. In addition to exchange, the interface may allow for generating music from a first device and then streaming to a second device, such as a gameplay device. The interface may also be configured for transmitting data to generate music, such as metadata to create music. The interface and processes described herein may also allow for a device, such as a game console or network to be used as an assistant device to render music for another device.

Customization of audio and gaming music can have a large impact on a gaming experience. Interface customization may include determination and communication of at least one user preference for gaming music, determining a game state, and generating music based on the at least one user preference and the game state. Musical preferences may be collected for users to generate dynamic music and to improve a gaming system's ability to generate a customized experience. Musical preferences can include identification of one or more of genres, specific song titles, indications of preferred types of music, music identified for certain gaming activities, user feedback, spoken language, seed music, and country of origin. Musical preferences can include rankings or orders of play for musical styles, tracks, volume, frequencies and output. According to embodiments, gaming music may be generated based on emotional cues of a game scene. Music may be controlled to be more prominent or less obtrusive to a game state.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

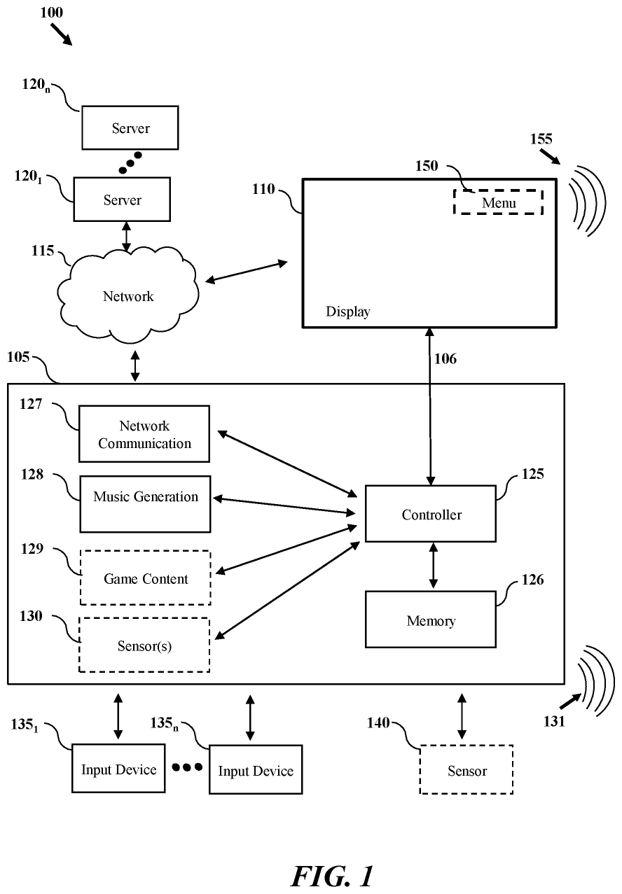

FIG. 1 is a graphical representation of customized music generation according to one or more embodiments. According to embodiments, customized music generation may be provided by a device and/or a system. A system can include one or more components and devices. FIG. 1 illustrates system 100 according to embodiments which can include device 105. Device 105 may be one or more of a gaming console, computing device and electronic device in general configured to output gaming content 106 to a display. With respect to gaming content, device 105 may be configured to output data for presentation by a display, or visual output device in general, including graphics (2D and 3D), sound and data. Device 105 may also be configured to output non-gaming content, such as video content, visual content, audio content, etc. Embodiments describe generating dynamic gaming music for electronic games and gaming, however it should be appreciated that the principles of the disclosure may be applied to other forms of media and non-gaming content. As such, device 105 and system 100 may be used to generate customize music for one or more applications.

According to embodiments, device 105 is configured to output data 106 and/or content to display 110. According to embodiments, display 110 may be separate from or part of device 105. Device 105 may be configured for network communication by way of network 115 with one or more servers 120₁₋ₙ. Device 105 may be configured to receive one or more of user data, game data and music data from servers 120₁₋ₙ. Servers 120₁₋ₙ may be configured to store one or more of user data, game data and music data.

FIG. 1 depicts a device configuration according to embodiments. Device 105 may relate to a console, media device, and/or handheld device configured for generation of gaming music. According to embodiments, device 105 includes controller 125, and memory 126. Device 105 may also include network communication module 127, and music generation module 128. Device 105 may also optionally include game content 129 and one or more sensors 130.

Controller 125 may relate to a processor or control device configured to execute one or more operations stored in memory 126, such as processes for generation of gaming music. Controller 105 may be coupled to memory 126, network communication module 127, and music generation module 128. Memory 126 may be non-transitory memory configured to provide data storage and working memory operations for device 105. Memory 126 may be configured to store computer readable instructions for execution by controller 125 for one or more processes described herein. Network communication module 127 may be a communications module configured to receive and transmit network communication data.

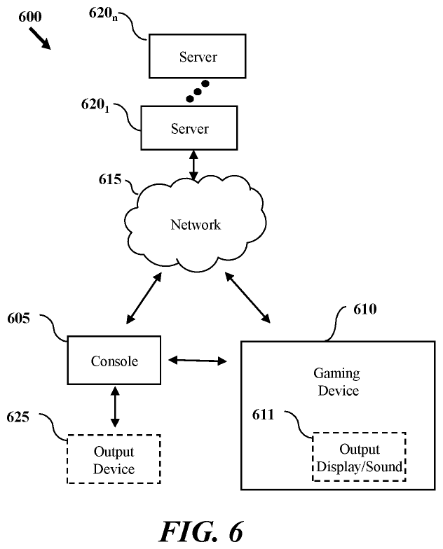

According to embodiments, device 105 may be configured to provide interface generation of gaming music by way of a software interface service. A software interface service may include one or more modules and/or executable code for a device, such as device 105, a server, such as servers 120₁₋ₙ, and handheld gameplay device. As discussed with reference to FIG. 6, a device may use the software interface service for generating music with game media on the device or received by way of a network. In addition, a software interface service may be utilized by devices for exchange of gaming music, data for generating gaming music and communication of data. Network communication module 127 may be a communications module configured to detect, process and utilize one or more software interface services. Network communication module 127 may be configured to provide an API for exchange with game media of device 105. According to embodiments, network communication module 127 may be configured to provide an API for communication with one or more of servers 120₁₋ₙ. communication data.

According to one embodiment, controller 125 may be configured to determine one or more parameters and user preferences for gaming music. One or more of user preferences, interactions and parameters for dynamic music generation may be determined and used by controller 125. According to embodiments, music generation module 128 may perform music generation operations. Music generation module 128 may include voicings, musical motifs, musical patterns and parameters to generate music for a game, including prior to, during and post-game play. In addition to gaming, dynamic music generation may be performed for presentation of menus and/or in association with operations of device 105 to act as a gaming console. Music generation module 128 may be configured to perform one or more learning or training operations to allow for music generation. Music generation module 128 may also store one or more data parameters for use in generating gaming music.

Device 105 may be configured to receive gaming media (e.g., card, cartridge, disk, etc.) and output visual and audio content of the gaming media to display 110. Device 105 may be configured to receive data from one or more of servers 120₁₋ₙ to present and output game content, which may be stored in memory 126. For network games, device 105 may receive game data from a network source, such as servers 120₁₋ₙ, and may be configured to generate gaming music for the game data.

According to embodiments, device 105 may include one or more optional sensors 130. Optional sensors 130 may include one or more of audio (e.g., sound), optical (e.g., camera) and spatial (e.g., presence, proximity, etc.) sensors for one or more of collecting user feedback, sensing user environment and for generating gaming music in general. Device may include one or more speakers to generated audio output, shown as audio 131. When connected to an external device, such as display 110, one or more speakers of the external device may be used to output audio.

Device 105 may be configured to receive input from one or more peripheral devices, such as input devices 135₁₋ₙ. Input devices 135₁₋ₙ may be controllers or input devices in general configured to provide controls for device 105 and game control. Device 105 may be configured to operate with one or more external sensors, such as optional sensor 140. Optional sensor 140 may be configured to detect audio in the location of a user, and/or presence of viewers. Display 110 may include sensors, such as optional sensors 140.

System 100 may include display 110 for output of visual and audio of an electronic game and/or output of device 105. According to embodiments, display 110 may display control elements of device 105, such as optional menu 150, which may be used to interface with device 105. Display 110 may output audio 155 based on data 106 received from device 105.

According to embodiments, device 105 may be configured to generate gaming music based on user preferences. According to other embodiments, device 105 may be configured to generate gaming music based on user interactions with a gaming system. In yet other embodiments, device 100 may generate gaming music based on parameters for customized audio spectrum generation. Device 100 may utilize one or more operations of processes 200, 600 and 800 and processes in general described herein. It should also be appreciated that system 100 and its components may be configured to perform operations of device 105.

System, devices and processes are described herein to generate gaming audio, such as gaming music. According to embodiments, gaming audio may be generated dynamically, such that it is not pre-constructed. Dynamic gaming music may be generated to include audio having one or more of a melody, rhythm, and harmony. Dynamic gaming music may be generated to include one or more tones (e.g., notes), tone progressions, rhythmic beats, and percussive elements provided by one or more musical voicings (e.g., instruments, synthesizers, etc.). Unlike conventional gaming music which is prerecorded, dynamic gaming music may be generated by system 100 or device 105 for a current gaming situation, player and game play environment. Dynamic music may be generated using one or more motifs trained to include one or more of melody, rhythm, and harmony components, such that device 105 may use a motif to generate audio output for the game based on a game situation and/or one or more parameters. In the context of user preference customized generation of gaming music, device 105 may generate music for the launch screen of a game title, such that one or more music motifs are selected, and the device selects one or more voicings for the motifs based on the game. According to embodiments, selection of a motif, selections of voicings and output of the motif may be based on a user preference. As discussed herein, electronic gaming is a worldwide activity, accordingly popular music in one region of the world may favor music with strong rhythmic components, whereas another region may favor more ambient sounds. Moreover, a user preference may not match with musical styles associated with a region. Embodiments allow for tailoring and modifying dynamic music to account for a particular user without requiring a game developer to generate a near infinite number of pre-recorded tracks.

By providing dynamic gaming music, system 100 and device 105 can provide many forms of musical output. According to embodiments, user preference customized generation of gaming music is provided to customize dynamically generated gaming music to provide a more personalized experience. Technically, dynamically generated gaming music does not require pre-recording of music for each user's preference. As discussed herein user preference can include one or more preferences directed to a musical style, genre, specific title, indications of preferred types of music, music identified for certain gaming activities, user feedback, country of origin, worldwide region, language preference and even user environment.

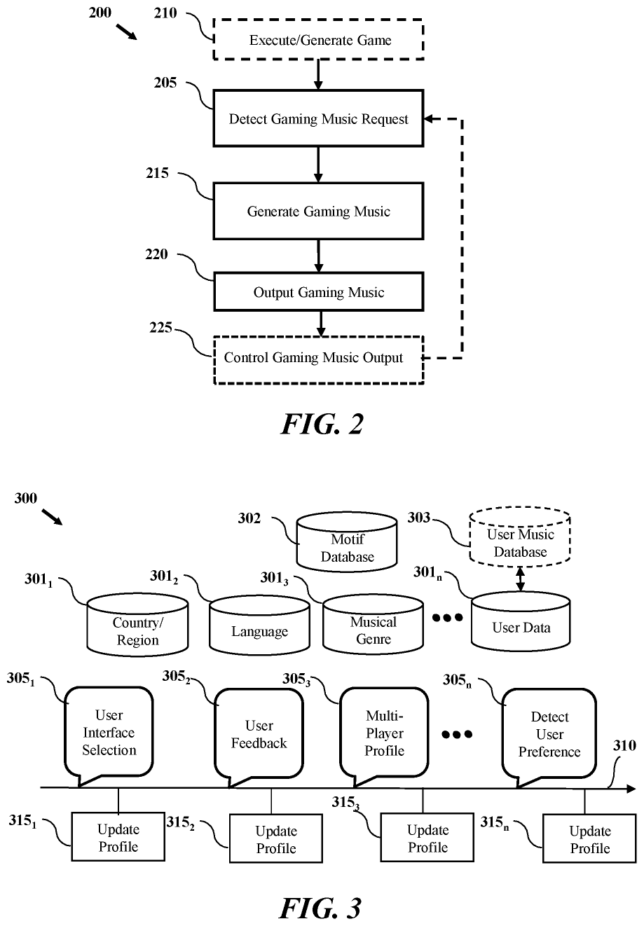

FIG. 2 illustrates a process for interface customized music generation according to one or more embodiments. Process 200 may use a software interface service to generate gaming music. Process 200 may be employed by a device, such as device 105 and/or controller 125 of FIG. 1, to generate gaming music. Operations of process may be performed by a server (e.g., servers 120₁₋ₙ) for network based games. Process 200 may also be performed to aid in generating dynamically generated music for games on a device and between devices. Dynamic generated game audio may be generated for a current game situation, that is not pre-constructed, and as such, can provide flexibility to customize the audio to one or more of a current gaming situation and player that will hear the audio. Process 200 provides solutions to generate music when resources are not available in game media or by a gaming device. Process 200 may be initiated by a device (e.g., device 105) receiving a gaming music request at block 205. The gaming request may be based on a game executed of generated at optional block 210. According to embodiments, a device (e.g., device 105) may execute media for gameplay. According to other embodiments, a server (e.g., servers 120₁₋ₙ) may execute and/or transmit data for gameplay at optional block 210 and receive a gaming music request at block 205. According to embodiments, one or more operations performed by a device in the description of process 200 may be performed by a server.

According to embodiments, process 200 includes detecting a request for gaming music at block 205. Detecting the request ay include receiving the request including at least one parameter for a game state by way of a software interface service. Embodiments include allowing execution of code for operating game media, present on a device, received form a server, and/or data combined from media and a network server, with a software interface service. The software interface service may provide a code interface (e.g., software) for one or more of communication, user interface player controls, acquisition and packaging of data, rights clearance, analytics, tracking and payment and metadata management. According to embodiments, the software interface service provides a medium for game media to interface with software of a device. At block 205, the gaming music request may be detected by receiving a communication formatted according to the software interface service to include the at least one parameter for the game state and music type. By way of example, one or more software formats (e.g., REST, SOAP, etc.) may be used to provide a request to operational code of the device. When game media is resident or executed by a device, the request may be detected based on operations of the device to execute the code. When the device operates to support another device, a request may be received by the device by network communication and an application programming interface (API).

According to embodiments, the gaming music request detected at block 205 may include a request for music that is formatted to allow for software of the device to interpret the request. In addition, the request for music at block 205 may include one or more parameters to allow for generating music. According to embodiments, the request for music at block 205 may include a game state corresponding to a current gaming situation within an electronic game. By providing a game state, a music generator may have some understanding of the type of music to be generated. Requests for music can include at least one parameter for indicating a type of music. Parameters for gaming music can include at least one of a music genre, music style, song title, identification of a musical artist, composer, user feedback, and musical preference.

One or more user preferences may be determined for a user. A gaming device, console or system may identify a user through selection of a user profile. In the absence of a user profile, the device may associate a user with one or more of an account, sign-in and identifier (e.g., email address, call sign, etc.). According to embodiments, detecting the at least one user preference for gaming music includes determining a user preference from user profile data. Profile data may include one or more of language of preference, region of preference, user location and user selections with a gaming system.

Detecting gaming music preference for a user and information about users may be collected actively and/or passively by a device. Passive collection of information can be accomplished through music choices that the player has made on the same system or a device in which the game is played, such as songs played, or playlists created by the player. According to embodiments, passive collection of information can be based on music choices made by the player or user account using any device where choices are made by the player or made in association with a user account, such as a mobile phone, tablet, computer, music player, game console, receiver, disc player, car stereo, smart TV, or jukebox. When determining a user preference, more emphasis can be placed on songs played by the player while playing games of a similar style. Passive collection may also include collection of data from a user profile. Process 200 may include detecting player preferences from one or more devices and network systems by way of an application programming interface (API).

At block 215, process 200 may include generating gaming music in response to the request. Gaming music may be generated dynamically to include at least one musical motif. In certain embodiments, music is generated that is ready for output by a device. According to embodiments, one or more of music fragments or metadata may be generated to allow another device to generate music. Generating music can include selection of at least one motif based on the at least one parameter for the game state. Generating gaming music can include selection of a musical motif for game elements of the game state. For example, the type of game, game setting, game characters and/or emotional data assigned to a game state may be communicated with music requests and used to generate game music. Selection of motifs for game music may also be directed by the at least one user preference. Process 200 allows for generating music according to a music request and one or more musical preferences of a user. Generating gaming music can include selection of a music library based on the user preference and generating the gaming music from one or more motifs of the music library. Music may also be generated based on one or more users (e.g., players) of a game.

At block 220, process 200 includes outputting gaming music. According to embodiments, outputting gaming music can include output of dynamic music in coordination with output of gaming content. A gaming device such as a gaming console may generate the gaming music for gaming media and output the music in coordination with video or display output. According to embodiments, a device or console may support another device such that outputting gaming music includes output of dynamic music by way of the software interface service to another device (e.g., a handled gaming device). According to embodiments, for a server providing gaming data for a device, such as a media player, handheld device, tablet, mobile phone, etc., outputting the gaming music includes transfer of metadata for creation of dynamic music by way of the software interface service.

Process 200 may include optional block 225 for controlling gaming music output. Output of gaming music may include controlling one or more of melody, rhythm, and style of output based on game play. For example, situations of heightened pressure in a game, such as nearing completion of a task or defeating an obstacle, may be detected by the device based on a game vector and as such one or more characteristics of gaming music may be adjusted at block 225. According to embodiments, controlling gaming music output at block 225 may include modifying one or more motifs selected in response to a change in game state. According to embodiments, controlling gaming music output at block 225 may include terminating output of gaming music. Controlling gaming music output may be based on one or more user inputs to a device.

FIG. 3 illustrates a graphical representation of user preference customization according to one or more embodiments. According to embodiments, generating gaming music and generating game audio may be based on parameters to define one or more attributes of the music and/or audio to be output. Parameters may be used to define motifs that may be combined. A device may store parameters 300 for output of music and audio. A device may also store parameters for a user including one or more of a preference, ranking, game specific selection, history of music played, user interactions and user feedback. Parameters may be stored in libraries 301₁₋ₙ. According to embodiments, country/region library 301₁ can store one or more musical patterns, rhythms and sounds for each of a plurality of regions, and countries. By way of example, a North American region may include musical styles including but not limited to rock, country, hip-hop and classical music styles. Alternatively, a European region may include musical styles including but not limited to dance, traditional music, rock, and popular music. Country/region library 301₁ may include parameters to identify music and audio preferences for one or more particular countries, regions of a country, and geographic regions. Country/region library 301₁ may also include a global category including all music styles of the system. Language library 301₂ may include one or more terms, or sounds associated with a language. According to embodiments, language library 301₂ may identify one or more sounds to avoid, such as an unpleasant sound or offensive language associated with one or more user preferences for language and/or nationality. Accordingly, generating gaming music may avoid one or more sounds associated with a user preference of sounds to avoid mapped to one or more languages and nationalities.

According to embodiments, musical genre library 301₃ can store one or more characteristics of music associated with musical genres including chord progressions, rhythmic patterns, voicings, fills, and song structure. User data library 301ₙ can store one or more preferences or parameters associated with a user. According to embodiments, user data library 301ₙ can store one or more dynamically generated tracks or playlists for replaying by a user. According to embodiments, user data library 301ₙ can store one or more preferences or parameters associated sounds to be avoided and sound outputs to avoid. By way of example user data library 301ₙ can store one or more user preferences, which may be user indicated and/or detected by a device, for individual sounds or sound categories to avoid including one or more of high-pitched sounds and sounds with sudden changes in volume (e.g., increasing, decreasing, etc.).

A device may also use a motif database 302 including one or more motifs that can be used to generate music. Motifs may be associated with one or more of emotions and situations associated with a game. For example, a game including a chase scenario may include music to accompany the chase with one or more motifs associated with a level of risk or stage of the chase. Motifs that are used to generate the music may correspond to elements in the game. For example, a motif for a particular enemy can be included in the motifs used for generating music when the enemy is pursuing the player in a chase and the motif would no longer be included if the enemy were no longer included in those pursuing the player in the chase. Motifs can also provide building blocks of song elements that may be used to generate music that is not an arbitrary collection of sound. According to embodiments, a motif database may include song elements that are generated from machine learning to generate music and/or audio elements for gaming. According to embodiments, a device may optionally obtain or identify music from a user music database 303 that may be stored with one or more of a device or network location. A device and system described herein can be configured to pull or read one or more of musical artists, songs and playlists associated with one or more accounts that may be linked to a user.

Parameters 300 may be stored by a device (e.g., device 105) and/or in a network location (e.g., servers 120₁₋ₙ) accessible to the device. Dynamic music generation may be based on parameters 300 and one or more user preferences. According to embodiments, user preferences detected for one or more users may be stored by a device (e.g., device 105). When a device generates gaming music or gaming audio, one or more interactions with the device may be used for one or more of identifying, setting and storing parameters to generate gaming music and audio.

FIG. 3 illustrates user interactions 305₁₋ₙ associated with gaming music 310 output by a device. During gameplay and/or presentation of a game menu, gaming music 310 may be output and a device may detect one or more user interactions, such as user interactions 305₁₋ₙ. A device may be configured to update a user profile, such as actions to update profile 315₁₋ₙ. According to embodiments, one or more user interface selections, such as user interface selection 305₁ may be detected and a profile of a user may be updated, update profile 315₁, in response to the selection. By way of example, a user interface selection to indicate a preference of country/region, language, musical genre and gaming music in general may result in the device determining/updating a parameter for generating music. User interface selections may be one or more of a menu selection, volume control, mute action and game control. User feedback 305₂ may be one or more of a rating, review, acceptance and cancellation of gaming music output by the device. As a result of user feedback 305₂, update profile 315₂ may be performed. Multi-player profile 305₃ may be one or more preferences for a multiplayer gaming environment for gaming music. As a result of multi-player profile 305₃, update profile 315₃ may be performed. According to embodiments, detected user preferences 305ₙ may be one or more preferences determined by a device for gaming music, including but not limited to presence of viewers with a user, user preferences from a playlist, seed music, and ambient noise. As a result of device detected user preferences 305ₙ, update profile 315ₙ may be performed.

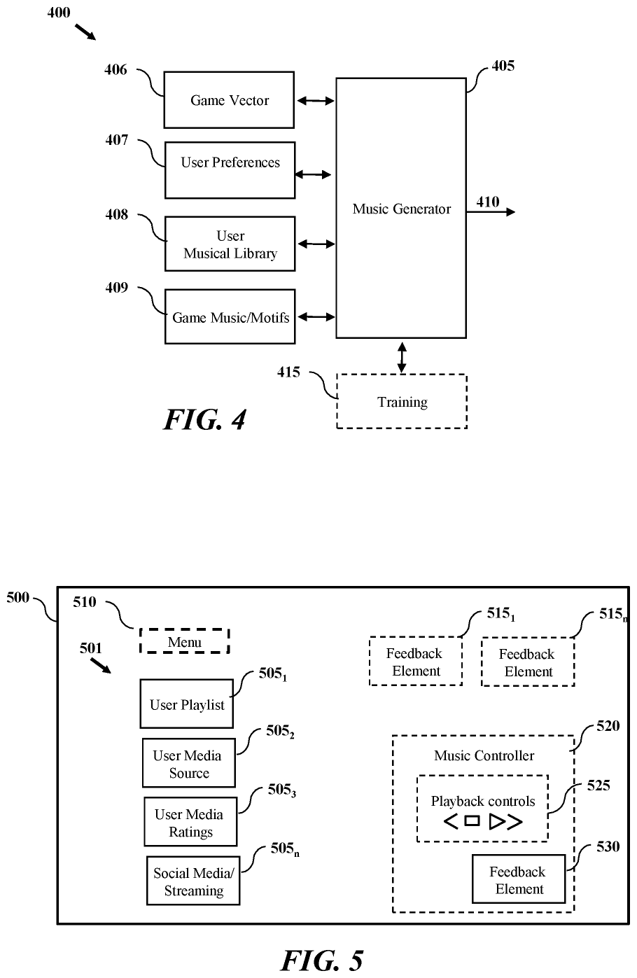

FIG. 4 illustrates a graphical representation of dynamic music generation according to one or more embodiments. According to embodiments, generation of gaming music may be performed dynamically, such that music and/or audio of an electronic game is determined and output during operations of a game. Dynamic music generation may employ use of one or more motifs that may be used to generate output. According to embodiments, dynamic gaming music generation 400 is performed by a music generator 405. Music generator 405 may be one or more components of a device, such as a controller or processor of a gaming console or electronic media player. Music generator 405 may be configured to output gaming music 410 based on one or more of game vector 406, user preferences 407, user musical library 408 and game music motifs 409. According to embodiments, a gaming console may generate and/or receive a game vector from game media, the game vector describing one or more operations and states of game play. The game vector may include a description of a game play scenario, game play type or mood associated with one or more game states. The game vector and one or more game states may be used to assess the type of music to generate. User preferences 407 are described above with reference to FIG. 3 and can provide one or more parameters for generating gaming music. User musical library 408 may provide one or more music titles which may be used a reference for generating music. For example, if a music library includes a particular type of music, such as techno, the type of music may be used as a reference for generating similar music. Game music motifs 409 may be provided by one or more of game media and a server to provide one or more musical elements that may be used to generate music. In certain embodiments, gaming music 410 may be generated independently of prerecorded music for a particular title. In other embodiments, gaming music 410 may modify or incorporate one or more game specific motifs.

According to embodiments, dynamic gaming music generation 400 may optionally include training 415 of one or more parameters for generating music. While user parameters may be employed to select, modify and output variations of motifs, the parameters and building blocks for a device to generate music may require training. By way of example, merging of musical styles may require training of rhythmic patterns when combining. Alternatively, parameter combination of certain tones and frequencies may require training to modify tonal or melodic progressions. Accordingly, music generator 405 may receive updated parameters from training 415 for generation of gaming music. According to embodiments, training 415 may be performed on a different device (e.g., second device, companion device, network device, etc.) than a device (e.g., first device) running operations of music generator 405. By way of example, parameters for training 415 may be received from one or more communications, such as network communication, by a device running music generator 405, such that received training data and parameters may be used by music generator 405.

According to embodiments, music generator 405 may generate gaming music 410 as a stream of output to another device (e.g., display, TV, etc.) or one or more speakers. According to embodiments, generated gaming music may include one or more musical phrases that may be output in a looping manner. Gaming music 410 may include one or more tracks (e.g., lead track, bass track, rhythm track, etc.) that may be independently controlled.

FIG. 5 illustrates a graphical representation of a user interface according to one or more embodiments. A device (e.g., device 105) may be configured to display one or more graphical elements for detecting gaming music preferences, including user preferences, user interactions and audio spectrum preferences. FIG. 5 illustrates display 500 which may include user interface 501. User interface 501 can include graphical elements 505₁₋ₙ which may be selected and/or controlled to provide sample or seed music for a gaming music generator. User playlist 505₁ may be selected and/or interacted with to provide a gaming music generator access to song titles of interest to a user. User media source 505₂ may be selected and/or interacted with to provide a gaming music generator access to one or more media files or media including music or audio, such as an external media player. User media ratings 505₃ may be selected and/or interacted with to provide a gaming music generator access to song titles, artists, composers, musical tracks and audio sounds a user likes or dislikes. The ratings may be a reflection of the user's affinity or distaste for certain music or sounds. Social media streaming 505ₙ may be selected and/or interacted with to provide a gaming music generator access to one or more network services that include audio and music responses.

According to embodiments, user interface 501 may include display of menu 510 for access to one or more display elements including one or more of feedback elements 515₁₋ₙ and music controller 520 to control playback of music. Elements of user interface 501 may be displayed as overlays and/or separately from game content. Feedback elements 515₁₋ₙ may be selected for providing feedback of gaming music output with game play and may include elements for approving, changing and disapproving gaming music. Music controller 520 may include playback controls 525 to advance, reverse, stop, and play music. Music controller 520 may include a feedback element 530 to provide feedback for gaming music. Music controller 520 may operate as an in-game element, such as a juke box, that a user can interact with which will allow the music controller 520 to obtain information on user opinions of musical elements and compositions. Feedback from music controller 520 and/or feedback elements 515₁₋ₙ may be used to tune music generation to the player. The in-game element can be seeded with AI generated music clips that the AI could most benefit from player feedback about. Elements of user interface 501 may be accessed with an input device, such as a controller.

FIG. 6 illustrates a graphical representation of devices for interface customized music generation according to one or more embodiments. According to embodiments, customized music generation may be provided by a device and/or a system. One or more elements of system 600 may be configured to provide interface customized music. System 600 includes console 605 (e.g., a device), and gaming device 610. Console 605 may be configured to execute and present gaming media. Console 605 may operate similarly to device 105 of FIG. 1. As discussed above with reference to FIG. 1, a device may be configured to operate as an interface and to generate customized music for game media resident on the device or received from a network location. Accordingly, console 605 may be configured to generate gaming music for game media executed by a controller (e.g. controller 125) of the console. According to embodiments, the software interface service may be used by a device, such as console 605, to interface with software of game media. Console 605 may relate to a gaming console configured to execute and output gaming media. Console may be configured to output one or more of gaming music and gaming content to an output, such as output device 625 (e.g., TV, screen, sound system, etc.) and gaming device 610.

According to embodiments, one or more of servers 620₁₋ₙ may be configured to detect a request for gaming music by way of a software interface service. According to embodiments, a software interface service may be executed by a device, such as one or more of console 605 and gaming device 610, to generate and transmit requests via network 615 to one or more of servers 620₁₋ₙ. Network 615 may include one or more devices and components for wired and/or wireless network service. With respect to interface customization of gaming music, servers 620₁₋ₙ may be configured to detect one or more requests and generate gaming music in response to the requests. Servers 620₁₋ₙ may also be configured to output the gaming music and data to one or more of console 605 and gaming device 610.

According to embodiments, gaming device 610 may be a device, such as a handheld gaming device, tablet, mobile phone, etc., configured to execute gaming media stored on device 610 and/or received from another device such as console 605 and servers 620₁₋ₙ. In some embodiments, gaming device 610 is another gaming console. According to embodiments, interface customization of music may include gaming device 610 generating requests for gaming music to one or more of console 605 and servers 620₁₋ₙ.

Gaming device 610 may be configured to include output 611 to output data for presentation by a display, or visual output device in general, including graphics (2D and 3D), sound and data. Gaming device 610 may also be configured to output non-gaming content, such as video content, visual content, audio content, etc.

According to embodiments, one or more of console 605, gaming device 610 and servers 620₁₋ₙ may be configured to receive and utilize a software interface service for exchange of data. According to embodiments, gaming device 610 may be a device with limited processing power for presentation of gaming media and may generate requests for dynamic music to one or more of console 605 and servers 620₁₋ₙ. Software interface services may be used to provide a readable format of requests and to include elements requested by device, such as music type, game state, emotional component and user preferences. According to embodiments, a software interface service request may be output by gaming device 610 including at least one parameter for a game state. For example, the software interface service may format and encapsulate the request in a format that allows for interoperation with software of one or more of console 605 and servers 620₁₋ₙ. The software interface service may also package one or more parameters such as music type, user preference and game state to allow another device, such as console 605 and servers 620₁₋ₙ to generate music. The device receiving the request may generate the music, and transmit the music and/or metadata for generating music to gaming device 610 by way of the software interface service. For example, a return message or messages may be transmitted gaming device 610. According to embodiments, generated music and/or return messages may be streamed or transited in as a service that can be received and output by gaming device 610 using output 611. Software interface services may include one or more API, such as a REST (“representational state transfer”) format or SOAP (“simple object access protocol”) to provide access to data or web resources by using a uniform and predefined set of operations.

While this disclosure has been particularly shown and described with references to exemplary embodiments thereof, it will be understood by those skilled in the art that various changes in form and details may be made therein without departing from the scope of the claimed embodiments.

What is claimed is:

1. A method for interface customized generation of gaming music, the method comprising:
detecting, by a device, a request for gaming music by way of a software interface service, the request including at least one parameter for a game state;
generating, by the device, gaming music in response to the request, wherein the gaming music is generated dynamically to include at least one musical motif, the at least one motif selected based on the at least one parameter for the game state;
outputting, by the device, the gaming music.

2. The method of claim 1, wherein the request is formatted according to the software interface service to include the at least one parameter for the game state and music type.

3. The method of claim 1, wherein the request is received by the device by network communication and an application programming interface (API).

4. The method of claim 1, wherein the game state is a current gaming situation within an electronic game, and wherein the at least one parameter includes a type of music.

5. The method of claim 1, wherein the at least one user parameter for gaming music includes at least one of a music genre, music style, song title, identification of a musical artist, composer, user feedback, and musical preference.

6. The method of claim 1, wherein generating gaming music includes selection of a musical motif for game elements of the game state, wherein the selection of the motif is directed by the at least one user preference.

7. The method of claim 1, wherein generating gaming music includes selection of a music library based on the user preference and generating the gaming music from one or more motifs of the music library.

8. The method of claim 1, wherein outputting the gaming music includes output of dynamic music in coordination with output of gaming content.

9. The method of claim 1, wherein outputting the gaming music includes output of dynamic music by way of the software interface service.

10. The method of claim 1, wherein outputting the gaming music includes transfer of metadata for creation of dynamic music by way of the software interface service.

11. A device configured for interface customized generation of gaming music, the device comprising:
a memory storing executable instructions; and
a controller coupled to the memory, wherein the controller is configured to
detect a request for gaming music by way of a software interface service, the request including at least one parameter for a game state,
generate gaming music in response to the request, wherein the gaming music is generated dynamically to include at least one musical motif, the at least one motif selected based on the at least one parameter for the game state, and
output the gaming music.

12. The device of claim 11, wherein the request is formatted according to the software interface service to include the at least one parameter for the game state and music type.

13. The device of claim 11, wherein the request is received by the device by network communication and an application programming interface (API).

14. The device of claim 11, wherein the game state is a current gaming situation within an electronic game, and wherein the at least one parameter includes a type of music.

15. The device of claim 11, wherein the at least one user parameter for gaming music includes at least one of a music genre, music style, song title, identification of a musical artist, composer, user feedback, and musical preference.

16. The device of claim 11, wherein generating gaming music includes selection of a musical motif for game elements of the game state, wherein the selection of the motif is directed by the at least one user preference.

17. The device of claim 11, wherein generating gaming music includes selection of a music library based on the user preference and generating the gaming music from one or more motifs of the music library.

18. The device of claim 11, wherein outputting the gaming music includes output of dynamic music in coordination with output of gaming content.

19. The device of claim 11, wherein outputting the gaming music includes output of dynamic music by way of the software interface service.

20. The device of claim 11, wherein outputting the gaming music includes transfer of metadata for creation of dynamic music by way of the software interface service.
